(19) United States
(12) Patent Application Publication
(10) Pub. No.: US 2004/0015905 A1
(43) Pub. Date: Jan. 22, 2004

(54) Method for managing compiled filter code

(76) Inventor: Antti Huima, Espoo (FI)

Correspondence Address: FALK AND FISH, 16590 OAK VIEW CIRCLE, MORGAN HILL, CA, 95037, US

(21) Appl. No.: 10/035,604

(22) Filed: Oct. 26, 2001

(30) Foreign Application Priority Data
Oct. 27, 2000 (FI) 20002377

(51) Int. Cl. G06F 9/45

(52) U.S. Cl. 717/141

(57) ABSTRACT

According to the invention, the compiled packet filter code is managed in a plurality of pieces, not as a single unit as according to prior art. Preferably, the compiled packet filter code is managed in equally sized pages. When a filter rule is changed, added or removed, only the affected page or pages are changed, added or deleted. This allows for fast updates of the filter code.

### BACKGROUND OF THE INVENTION

1. Field of the Invention

The invention is related to processing of data packets in network elements, more particularly to packet processing based on filtering according to a set of rules. Especially, the invention is related to such a method as specified in the preamble of the independent method claim.

2. Description of Related Art

Packet processing based on filtering according to a set of rules is a widely known concept per se. An archetype of such solutions is the Berkeley packet filter distributed in the BSD 4.3 operating system (University of California, Berkeley, 1991, published for royalty-free worldwide distribution e.g. in the 4.3BSD net2 release). The BSD packet filter is described for example in the article by Steven McCanne and Van Jacobson: The BSD Packet Filter: A New Architecture for User-level Packet Capture, USENIX Winter 1993 Conference Proceedings, January 1993, San Diego, Calif.; published as a preprint dated Dec. 19, 1992. Other prior art mechanisms are presented for example in J. Mogul, R. Rashid, M. Accetta: The Packet Filter: An Efficient Mechanism for User-Level Network Code in Proc. 11th Symposium on Operating Systems Principles, pp. 39-51, 1987, and Jeffrey Mogul: Using screend to implement IP/TCP security policies, Digital Network Systems Laboratory, Technical Note TN-2, July 1991.

The logical rules used in packet filters take the form of simple comparisons on individual fields of data packets. Effectively, effecting a such comparison takes the form of evaluating a boolean (logical, truth value) expression. Methods for evaluating such expressions have been well-known in the mathematical literature for centuries. The set of machine-readable instructions implementing the evaluations is traditionally called the filter code. FIG. 2 illustrates a packet filter 200 with a stored filter code 201. Input packets 202 are examined one packet at a time in the packet filter 200 and only those packets are passed on as output packets 203 that produce correct boolean values when the logical rules of the filter code are applied.

The individual predicates (comparisons) of packet filter expressions typically involve operands that access individual fields of the data packet, either in the original data packet format or from an expanded format where access to individual fields of the packet is easier. Methods for accessing data structure fields in fixed-layout and variable-layout data structures and for packing and unpacking data into structures have been well-known in standard programming languages like fortran, cobol and pascal, and have been commonly used as programming techniques since 1960's.

The idea of using boolean expressions to control execution, and their use as tests are both parts of the very basis of all modern programming languages, and the technique has been a standard method in programming since 1950's or earlier.

Expressing queries and search specifications as a set of rules or constraints has been a standard method in databases, pattern matching, data processing, and artificial intelligence. There are several journals, books and conference series that deal with efficient evaluation of sets of rules against data samples. These standard techniques can be applied to numerous kinds of data packets, including packets in data communication networks.

A further well-known technique is the compilation of programming language expressions, such as boolean expressions and conditionals, into an intermediate language for faster processing (see, for example, A. Aho, R. Sethi, J. Ullman: “Compilers—Principles, Techniques, and Tools”, Addison-Wesley, 1986). Such intermediate code may be e.g. in the form of trees, tuples, or interpreted byte code instructions. Such code may be structured in a number of ways, such as register-based, memory-based, or stack-based. Such code may or may not be allowed to perform memory allocation, and memory management may be explicit, requiring separate allocations and frees, or implicit, where the run-time system automatically manages memory through the use of garbage collection. The operation of such code may be stateless between applications (though carrying some state, such as the program counter, between individual intermediate language instructions is always necessary) like the operation of the well-known unix program “grep”, and other similar programs dating back to 1960s or earlier. The code may also carry a state between invocations, like the well-known unix program “passwd”, most database programs and other similar applications dating back to 1960s or earlier. It may even be self-modifying like many Apple II games in the early 1980s and many older assembly language programs. It is further possible to compile such intermediate representation into directly executable machine code for further optimizations. All this is well-known in the art and has been taught on university programming language and compiler courses for decades. Newer well-known research has also presented methods for incremental compilation of programs, and compiling portions of programs when they are first needed.

Packet filtering techniques are especially advantageous in cases, where a high throughput of packets is desired. Real-time filtering of large volumes of data packets has required optimization in the methods used to manipulate data. Thus, the standard programming language compilation techniques have been applied on the logical expression interpretation of the rule sets, resulting in intermediate code that can be evaluated faster than the original rule sets. A particular implementation of these well-known methods used in the BSD 4.3 operating system has been mentioned in popular university operating system textbooks and has been available in sample source code that has been accessible to students in many universities since at least year 1991.

Packet filtering in the context of computer security has been addressed in the PCT patent application FI99/00536, which is hereby incorporated by reference. That application describes a system, in which the processing of packets is performed by two entities, namely a packet processing engine and a policy manager. The packet processing engine processes packets based on compiled filter code, and any packets which have no corresponding rule in the filter code are forwarded to the policy manager component. The policy manager component takes care of the processing of such non-regular packets, for example by performing the necessary action on the packet. The policy manager can also create a new rule for the engine for processing of similar packets in the future. The packet processing engine is implemented typically in the kernel space for performance reasons. The policy manager may be implemented in the user space, since the processing of non-regular packets for which no precompiled rule exists is more complicated than of regular packets, and since the processing of the relatively rare non-regular packets is not as time critical as the majority of the traffic, i.e. the regular packets.

Another patent document describing processing of packets according to certain security protocols based on packet filtering techniques is the U.S. Pat. No. 5,606,668. That patent describes a system, where a set of security rules are translated into a packet filter code, which is loaded into packet filter modules located in strategic points in the network. Each packet transmitted or received at these locations is inspected by performing the instructions in the packet filter code. The result of the packet filter code operation decides whether to accept (pass) or reject (drop) the packet, disallowing the communication attempt.

These kinds of packet filter processing mechanisms can advantageously be used for processing of the packets for IPSec protocol, since IPSec processing is rather complicated and as the IPSec protocol is used below any application protocols, the needed packet throughput can be very high. However, packet filtering can be used for many other purposes as well, basically for any purpose where packet classification is needed. Consequently, the concept of a packet filter is also known as “packet classifier”, see e.g. the landmark article PATHFINDER: A Pattern-Based Packet Classifier by Mary L. Bailey et al, Proceedings of the First Symposium on Operating Systems Design and Implementation, Usenix Association, November 1994, where a number of different uses for packet filtering are briefly mentioned.

Packet filtering presents a number of problems, which have not been solved by any prior art solutions. These problems arise especially in connection with high-speed processing of packets according to complicated sets of rules. Updating of a rule set causes a pause in the operation of the packet processing engine, especially when the frequency of updates is high, and the volume of processed packets is high.

### SUMMARY OF THE INVENTION

An object of the invention is to realize a method for managing packet filter code, which avoids problems associated with prior art. A further object of the invention is to realize a packet filtering system, which avoids problems associated with prior art.

The objects are reached by managing the compiled filter code in a plurality of pieces, whereby the filter code can be updated by updating a piece of the whole code.

The method according to the invention is characterized by that, which is specified in the characterizing part of the independent method claim. The computer software program product according to the invention is characterized by that, which is specified in the characterizing part of the independent claim directed to a computer software program product. The computer network node according to the invention is characterized by that, which is specified in the characterizing part of the independent claim directed to a computer network node. The system according to the invention is characterized by that, which is specified in the characterizing part of the independent claim directed to a system. The dependent claims describe further advantageous embodiments of the invention.

According to the invention, the compiled packet filter code is managed in a plurality of pieces, not as a single unit as according to prior art. Preferably, the compiled packet filter code is managed in equally sized pages. When a filter rule is changed, added or removed, only the affected piece or pieces of code are changed, added or deleted. This allows for fast updates of the filter code.

In an advantageous embodiment of the invention, the basic invention is further improved by shadow paging of packet filter code pages, which allows processing of packets to continue without interruption during packet filter code updates. Shadow paging provides consistency for the processing of a packet while some parts of the filter code are being updated. Shadow paging avoids any code inconsistencies which may result if certain pieces of code are changed, while packets are processed within the same branch of filter code that is being updated. Shadow paging also allows the existence of several generations of packet filter code, i.e. allows very frequent updating of the filter code without disturbing the processing of data packets.

In an advantageous embodiment of the invention, the basic invention is further improved by the use of a dual port memory element to store the compiled filter code. Such a memory element allows a second processing entity to change parts of the filter code via a second memory port while the main processor continues to process packets accessing the memory via a first memory port.

In certain applications of packet filtering it is advantageous, if the packet filter code does not contain any backward jumps. Such code is guaranteed to have a finite running time. However, when sections of code are added, deleted or replaced, one may end up in a situation, where a new piece of code to be placed in the code memory can only be placed in a memory area having lower memory addresses than a piece of code preceding it in the execution path. Consequently, if only forward jumps are allowed, multiple pieces of code need to be moved around to make space for the new piece of code in a suitable place according to its placement in the execution path of the filter code, which is a slow procedure. In an advantageous embodiment of the invention this problem is alleviated by identifying each piece of code, such as each page of compiled code, with a reference number and using the reference numbers to ascertain that any jumps between pieces of code are not backward jumps in the sense of the main direction of the execution path of the code.

### BRIEF DESCRIPTION OF THE DRAWINGS

Various embodiments of the invention will be described in detail below, by way of example only, with reference to the accompanying drawings, of which

FIG. 1 illustrates a flow chart of a method according to an advantageous embodiment of the invention,

FIG. 2 illustrates a flow chart of a method according to a further advantageous embodiment of the invention,

FIGS. 3a and 3b illustrate an advantageous embodiment of the invention using shadow paging,

FIG. 4 illustrates a method according to an advantageous embodiment of the invention, and

FIG. 5 illustrates various other embodiments of the invention.

Same reference numerals are used for similar entities in the figures.

### DETAILED DESCRIPTION OF THE PREFERRED EMBODIMENTS

The exemplary embodiments of the invention presented in this description are not to be interpreted to pose limitations to the applicability of the appended claims. The verb “to comprise” is used as an open limitation that does not exclude the existence of also unrecited features. The features recited in depending claims are mutually freely combinable unless otherwise explicitly stated.

A. Description of a Method According to a First Aspect of the Invention

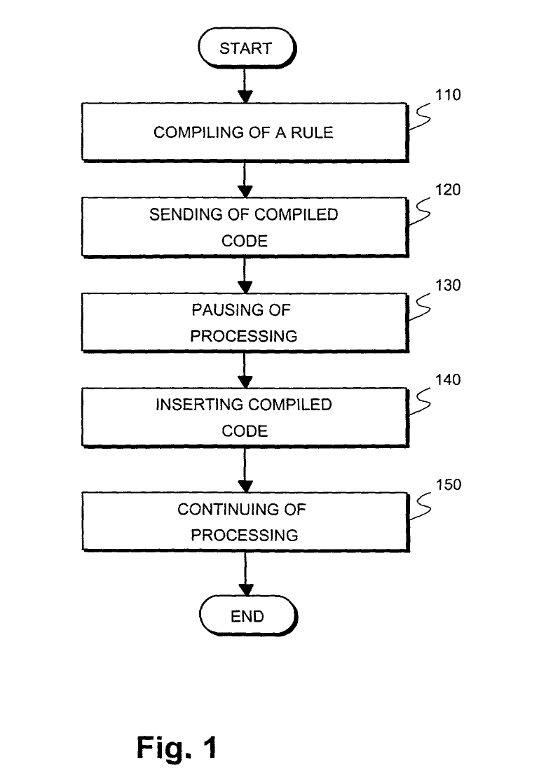

FIG. 1 shows a flow diagram of a method according to an advantageous embodiment of the invention. In step 110, a new or a modified rule for processing packets is compiled by the rule compiling entity, i.e. the entity responsible for compiling rules. In step 120, the compiled code is sent to the packet processing entity. After receiving the compiled code, the packet processing entity pauses 130 processing of packets at a suitable instant in time. Such a suitable instant may be for example such a time, when the execution point or execution points in the code regarding any packet or packets are not within the piece of code or pieces of code, which were sent in step 120. The packet processing entity may also block jumps to such pieces of code and wait until any execution point or points leaves the code to be deleted or replaced. In the next step 140 the packet processing entity inserts the new code within the compiled code used for processing, and continues 150 processing of packets. If the new code is intended to replace some of the existing code, the packet processing entity can for example simply overwrite the existing code in step 140, or delete the affected part or parts of the existing code.

The units in which the new code is managed can be individual bytes or arrangements of bytes. Advantageously, the unit is managed in pages of predefined size, which simplifies the management of the memory resource used for storing the compiled code. One or more such units can be inserted in a single inserting step 140.

The way in which the new compiled code is sent to the packet processing entity in step 120 is not limited in any way by the invention, since the implementation of the way of sending the code is very strongly dependent on the particular application of the invention and the hardware environment in which the invention is applied. For example, the code may be sent as a parameter to a message sent from an user mode rule compiling entity to a kernel mode packet processing entity. As a second example, the rule compiling entity can store the new compiled code in a memory means, and signal to the packet processing entity that the new code should be taken into use.

In such an embodiment, in which the invention is realized within a general purpose computing platform such as a computer having a unix-like operating system, the rule compiling entity is advantageously a user mode process, and the packet processing entity is advantageously a kernel mode process or a part of the kernel. In such environments, where the division of user mode processes and kernel mode processes do not exist, such as a typical dedicated router hardware platform, these two entities can simply be two separate processes. However, the invention is not limited to any specific organization of actions and duties within certain processes, since as a man skilled in the art knows, a given functionality can be constructed in many different ways.

B. Description of a Method According to a Second Aspect of the Invention

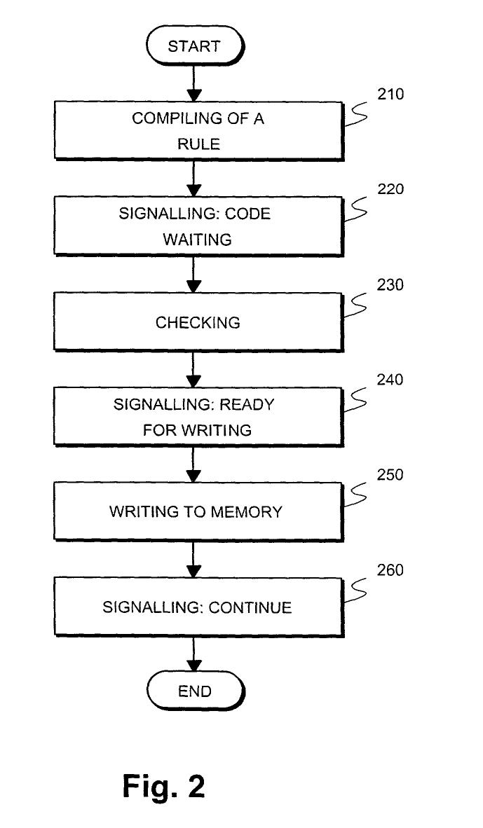

FIG. 2 illustrates such an embodiment of the invention, where the rule compiling entity writes the new code into a common memory area accessed also by the packet processing entity. In step 210, the rule compiling entity compiles a new or a changed rule, after which it signals 220 to the packet processing entity that new code is waiting to be used. The rule compiling entity may also explicitly indicate, which parts of the code are affected. In step 230 the packet processing entity checks if any packet processing operations are executing. If the packet processing entity knows which parts of the code are to be replaced, it suffices to check if any packet processing operations are executing within the affected parts of code. When no packet processing operations are executing within the affected parts or code or within the whole compiled code, the packet processing entity signals 240 to the rule compiling entity that the rule compiling entity can write to the common memory area. In the next step 250 the rule compiling entity writes the new piece of code or pieces of code to the common memory area, after which the rule compiling entity signals 260 to the packet processing entity that the packet processing may continue.

A method according to FIG. 2 is especially advantageous in such an embodiment of the invention, in which the packet processing entity is a first processor and the rule compiling entity is a second processor, which both can access a dual port memory circuit. Further, the use of a dual port memory component is very advantageous in embodiments of the invention employing shadow paging in the management of filter code pages.

C. Description of a Further Aspect of the Invention

In a further advantageous embodiment of the invention, the basic mechanism is improved further by the use of shadow paging. Shadow paging allows updating of the filter code without waiting for execution points associated with packet currently under processing to leave the affected pieces of code. Shadow paging is in itself an old principle, which has been used at least since the 1970's. For clarity, we describe an example of the use of a basic shadow paging technique for managing different versions of filter code for processing of data packets.

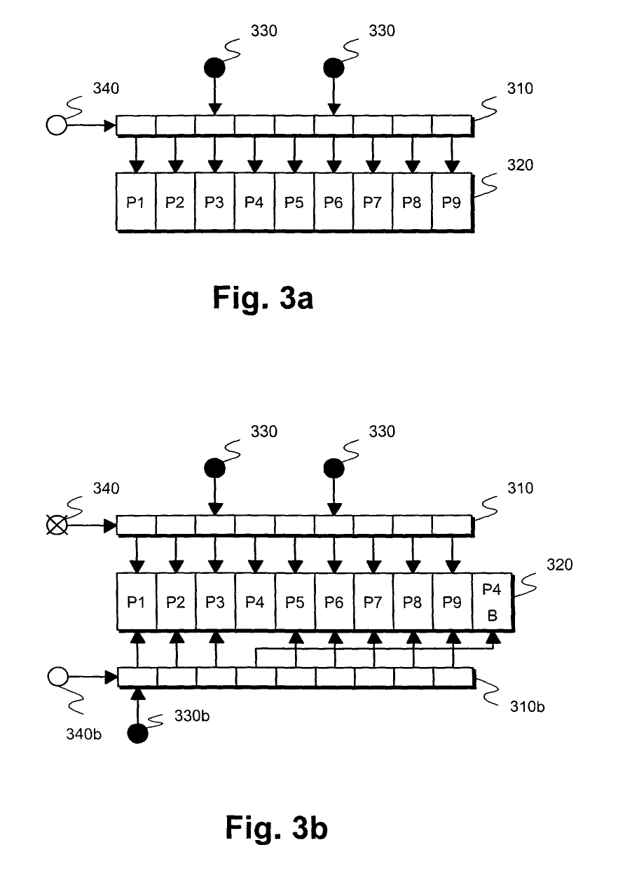

One examplary way of implementing shadow paging according to an advantageous embodiment of the invention is illustrated in FIGS. 3a and 3b. FIG. 3a illustrates a memory area 320 comprising a plurality of memory pages P1 to P9, a data structure 310 comprising pointers pointing at said pages, and a base pointer 340 pointing at the start of the data structure 340. FIG. 3a also illustrates two execution points 330 associated within packet under processing. The execution points 330 illustrate, in which places a thread or a process processing a packet is within the filter code stored in memory area 320. When a new packet arrives for processing, the processing starts at the page pointed to by the first page pointer of the data structure 310, to which the base pointer 340 points. FIG. 3a illustrates the starting point of this example, i.e. the situation before an update of the filter code. FIG. 3b illustrates the situation after an update of the filter code. In this example, the update procedure resulted in a new version P4B of the code page P4. The old code page P4 is not overwritten with the new version P4B, but stored in a free location in the memory area 320. A second data structure 310b comprising pointers pointing at code pages in memory area 320 is created, in which the page P4B is referred to instead of the old page P4. The second data structure 310b is subsequently used for processing of any new packets, i.e. the pointer 340b pointing to the second data structure 310b is used as the new base pointer 340b. This is illustrated by a new execution point 330b pointing to the second data structure 310b in FIG. 3b. The old base pointer 340 referring to the first data structure 310 is not used as the current base pointer any more, which is indicated by the crossed circle 340 in FIG. 3b. Execution points 330 continue to traverse the old set of code pages, i.e. those packets under processing at the time of update are processed according to the old code pages. When the processing of all such packets has ended, i.e. when no execution points refer to the first data structure 310, the old base pointer 340, the first data structure 310, and the old code page P4 can be released from memory 320.

We note that the example of FIGS. 3a and 3b is only a simplified example, and is meant for illustrative purposes only. The invention is not limited in any way to shadow paging techniques illustrated in FIGS. 3a and 3b, since a man skilled in the art can devise many other different ways of implementing shadow paging.

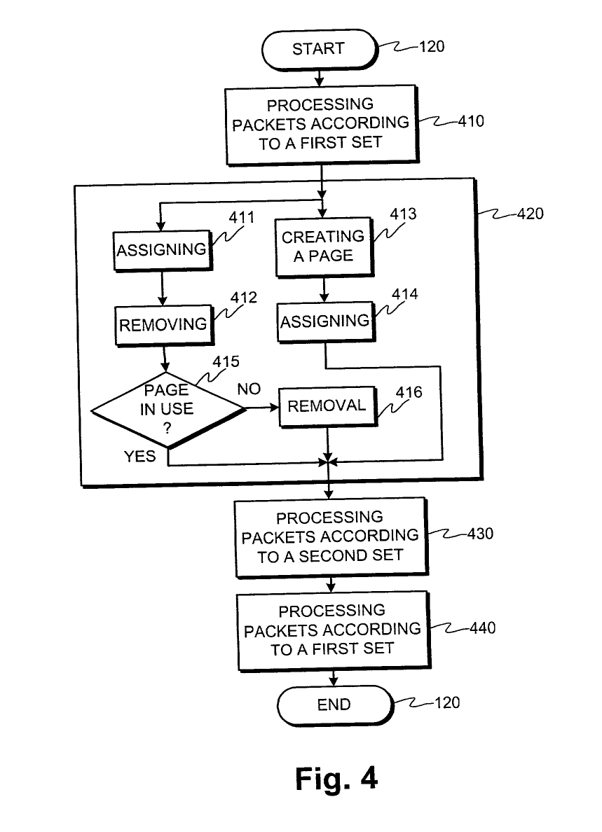

According to an advantageous embodiment of the invention, a method for managing compiled filter code used for processing data packets is provided. This aspect of the invention is illustrated in FIG. 4. According to an advantageous embodiment of the invention, the method comprises the steps of

processing 410 packets according to at least one first set of code pages,

creating 420 a second set of code pages to represent the set of code pages to be used after a certain point in time,

processing 430 packets received after said certain point in time according to said second set of code pages, and

processing 440 packets received before said certain point in time according to said at least one first set of code pages.

Sets of code pages can be represented in many different ways. For example, a set of code pages can be represented by an array of pointers, which point to the first memory locations of the code pages. In such an example, the step of creation of a second set of code pages can comprise the steps of creating an array of pointers or reusing an already existing array of pointers and filling the array of pointers with addresses of code pages. The certain point in time is simply the time when the second set of code pages is taken into use, which can happen after the set of pages is ready. After the new second set is taken into use, any new received packets are processed according to the new second set, and any previously received packets whose processing has not ended yet are processed according to a previous set of code pages. Very frequent updating of the compiled rules can lead to a situation, where there are more than two sets of code pages in use at a specific point of time.

The processing of new received packets according to the second set continues until a new code page update is needed, whereby the second set becomes one of the old code page sets (i.e. one of the at least one first sets) and a new code page set is created.

In a further advantageous embodiment of the invention, the step of creating a second set of code pages comprises the steps of assigning 421 members of an existing code page set to be members of said second set of code pages, and removing 422 a code page from said second set of code pages.

The step of removing a code page from a set of code pages represents removal of the membership of the code page from the set. This can be effected in many ways depending on how the set is implemented in a particular application of the invention. If, for example, the set is implemented as an array of pointers to code pages, a code page can be removed from the set simply by removing the corresponding pointer from the array, or for example setting the corresponding array element to a null value or to another predefined value. The step of assigning members of an existing code page set to be members of said second set of code pages can be implemented simply by copying the contents of the data structure representing the first set into a data structure representing the second set, such as by copying a pointer array representing the first set to a pointer array representing the second set.

In an advantageous embodiment of the invention, creation of the second set comprises phases, in which a data structure for a new code page set is created, content of a previous code page set data structure are copied into the new data structure, desired code page updates are performed on the newly filled data structure, and the data structure i.e. the second set is taken into use. However, details of the creation of the second set can be implemented in many different ways. For example, it is possible to consider the code page updates already during the filling of the data structure of the second set, so that those code pages which cause them to be left out of the second code page set are never assigned to the second code page set in the creation process. The invention is not limited to any specific method or methods of creation of a code page set.

In a further advantageous embodiment of the invention, step of creating a second set of code pages comprises the steps of creating 423 a new code page, and assigning 424 said new code page to be a member of said second set of code pages.

In a still further advantageous embodiment of the invention, the step of creating a second set of code pages comprises step of removing 416 a code page from the memory element storing the code pages, when the code page is not any more a member of any set of code pages in use. The check 415 of whether a code page is in use by any of currently existing code page sets can be conveniently performed after the code page is removed from a code page set, as illustrated in FIG. 4.

The use of shadow paging in together with page-based updating of filter code is especially advantageous in applications, where a high volume of data packets is processed using a complicated, frequently updated rule set. Any pauses in processing, even relatively short ones allowed by updates on page-by-page basis according to the current inventions, cause loss of performance in such applications. Shadow paging guarantees that a packet whose processing has already begun, will be processed to the end using those rules in effect when the processing of the packet was started. Shadow paging also allows frequent updating, since the principle of shadow paging allows for a plurality of generations of filter code to be in concurrent execution. In other words, the interval between subsequent filter rule updates can be shorter than the average processing time of a packet, whereby many updates can occur during the average processing time of a packet. This is a large advantage, since for obtaining a large throughput in an application where the filter rule set is complicated concurrent processing of packets is applied to overcome the throughput bottleneck created by relatively long processing times of packets. Therefore, in a high volume application, there can be a large number of packets being processed in various stages of processing at any given time instant. Shadow paging allows the processing of packets to continue smoothly even when the filter code is updated.

D. Description of Various Embodiments of the Invention for Managing of the Order of Pieces of Code

In an advantageous embodiment of the invention, the compiled filter code is managed in units of pages having a predefined length, and each page is associated with a reference number. The reference numbers are used by the rule compiling entity for ensuring that the code does not contain backward jumps instead of comparing the jump addresses in the code. This allows the pages to be placed in arbitrary order in memory. Preventing backward jumps in the filter code is advantageous, since it guarantees that the filter code will execute through in finite time. In an advantageous embodiment of the invention, the reference numbers are assigned to code pages so that the reference numbers reflect the order of the code pages within the execution path of the code. In other words, if a first code page contains code which is after the code of a second code page in the execution path, the reference number of the first code page is later in an ordered sequence of reference numbers. Therefore, finding out if a jump which goes outside of the current code page is a backward or a forward jump can be accomplished simply by comparing the reference number of the current page to that of the page being jumped to. The reference numbers can be assigned so that they form a continuous sequence of numbers; however, this has the drawback that inserting a new page between two existing page would each time require the renumbering of one or more pages. In a further advantageous embodiment of the invention, the reference numbers are chosen from a set of numbers which is very large in comparison with the average amount of filter code pages, and the reference numbers are assigned so that a large number of unused numbers remain between each two nearest reference numbers, if possible. In the most cases, such an arrangement allows the assignment of a reference number for a new filter code page between two already used reference numbers without extensive renumbering of existing filter code pages. In such an arrangement, renumbering becomes necessary only if a new page should have a reference number between two reference numbers, which are already consecutive, or if a new page should be inserted before the first page in a situation where the reference number of the first page is the first number in the set of allowed reference numbers, or after the last page in a situation when the reference number of the last page is the last reference number in the set of allowed reference numbers.

In a still further advantageous embodiment of the invention, the reference numbers are chosen using an algorithm similar to that presented in section 2 of the article P. F. Dietz and D. D. Sleator: Two algorithms for maintaining order in a linked list, Proc. 19th Annual ACM Symp. Theory of Computing, 1987, pp. 365-372, which is incorporated herein by reference. This algorithm, which they call “A Simple O(log n) Amortized Time Algorithm”, maintains the reference number in an efficient way. The reference numbers of the pages are maintained as a circular list, i.e. in the circular list the reference number of the last page in the execution path is followed by the reference number of the first page in the execution path. One of the pages, preferentially the first page, is a base page whose reference number is a base reference number, and values v being compared for determining the order of any two pages are

v(x)=r(x)−r(b)modM

where r(x) is the reference number of a page x being compared, r(b) the reference number of the base page, and M the size of the set of allowed reference numbers {0, 1, 2, . . . , M−1}. M is preferably very much larger than the expected number of code pages at any given time, so that the amount of unused reference numbers between any two consecutive reference numbers would be very large to minimize the probability of renumbering becoming necessary.

New reference numbers are chosen so that when a new page n is inserted between two old pages o1 and o2 in the sense of the circular list of reference values, v(n) has a value such that v(o1)<v(n)<v(o2). For example, the new reference value can advantageously be chosen so that v(n)=int ((v(o1)+v(o2))/2) as described in the Dietz and Sleator article, the int function giving the integer part of its argument. However, any other reference value giving a v between v(o1) and v(o2) can be chosen as well. In the case that the page o1 is the last page in the execution path, whereby o2 would be the first page in the execution path, the value of M is used instead of the value v(o2). In the rare case that v(o1)=v(o2)−1, renumbering of pages is needed. One very efficient algorithm for renumbering is discussed in the Dietz and Sleator article, but other algorithms could be used as well.

If v(y)>v(x) for two pages x and y, then y is after x in the execution path, i.e. a jump from x to y is a forward jump. The use of such a value v for comparison has the advantage that the choice of the reference number for the base page is arbitrary, which allows the change of the base page—for example in a situation, when a new page is inserted before the first page in the execution path of the filter code. This algorithm is very advantageous, since it minimizes the number of operations needed for maintaining the order of the code pages. Renumbering operations are quite costly, since in a typical application of the invention, the code pages are generated by a user space compiling entity and the code is executed by a kernel space packet processing engine, whereby the renumbering of existing code pages requires passing of messages between user space and kernel space, which is time consuming.

E. Description of Various Embodiments of the Invention for Production of Pieces of Code

E.1. A FIRST GROUP OF EMBODIMENTS

Various methods for producing the compiled pieces of code are discussed in the following. In principle, it is possible to obtain changed pieces of compiled code by compiling the changed set of rules, and comparing the results of the compilation to the previous compilation result on a byte-for-byte basis. Such a comparison results in one or more sequences of bytes, i.e. pieces of code, which can then be written to the memory area used for storing the compiled code. However, such a naive approach is most often not very advantageous. Advantageously, the compiled pieces of code are produced using incremental compilation techniques.

Incremental compilation is generally in the art understood as a process for producing compiled output from source code, in which process only a changed part of a section of source code is compiled, and compiled code corresponding to that part is produced using the result of a previous full compilation as an aid. For example, if one function definition in a source code file comprising code for many functions is changed, an incremental compilation process would take the changed definition of the function and produce compiled code corresponding to that function only, and take the compiled code into use by combining the compiled code in some way with the rest of the compiled program. In contrast, a normal, non-incremental compiling process would compile the whole source code file, and not only the changed function definition within the file. Incremental compilation is widely used e.g. in Lisp environments, in which such a newly compiled function can be taken into use even without ending the execution of the whole Lisp program.

In the context of the present invention, source code is a high-level description of the packet filtering rules and compiled code is the compiled filter code executed by the packet processing engine, and incremental compilation refers to compiling a subset of the whole set of current rules instead of the conventional way of compiling the whole set of current rules.

Incremental compilation is a widely known old concept, whereby general techniques for performing incremental compilation are not described here any further.

E.2. A Further Advantageous Embodiment of the Invention

In this section E.2, following, an advantageous way of performing incremental compilation according to an advantageous embodiment of the invention is described. According to this embodiment, the compiler represents rulesets internally as standard branching trees, where branches are taken based on the values that can be loaded from a packet. Calls to embedded rulesets are represented as pointers from a branching tree's leaves to the roots of another branching trees. However, to gain efficiency, similar subtrees are shared, and thus the trees are actually only directed acyclic graphs.

According to the present embodiment, adding a new rule to a branching graph is done by an algorithm that resembles much those used for merging OBDDs (ordered binary decision diagrams). The important aspect of the algorithm is that a hash table is used to memorize the result of merging part of the rule with a given node in the original graph. Later if the same merge is tried again the cached result is returned. This ensures that similar subgraphs are shared. Explicit merging of similar subgraphs otherwise does not need to be performed (as opposed to OBDDs) because when a new rule is merged in, it performs a noticeable change on all the leaf nodes in its range, because otherwise it could not be efficiently removed later.

Rule removal does not have a direct counterpart in the context of OBDDs. According to the present embodiment, removal is done so that the leaves of the branching graph that are affected by the removal of the rule are modified, and then similar subtrees are merged using a recursive algorithm that traverses the modified graph in bottom-up fashion.

The ruleset graph contains enough information for removing rules, so it needs to track wholly also such rules that are partially or completely shadowed by some other rule that has higher priority. However, this information is not required when generating the actual filter code, because the shadowed rules do not affect the final code. Therefore, according to the present embodiment, the compiler maintains another graph, a compressed branching graph, where the shadowed parts of rules are ignored. The compressed graph is much smaller than the original when there is much overlap in rules.

According to the present embodiment, the compiler performs incremental changes on the compressed graph on basis of the incremental changes done on the basic graph.

According to the present embodiment, when code is about to be generated, i.e. all changes for the current batch have been incorporated to the graphs, the compiler lists those nodes in the compressed graph that have been changed. Then those nodes are potentially moved around on the pages, and then the pages where the modified nodes reside are recompiled. As a result of moving the location of the compiled code for a node, all pages from which jumps to the moved node are made must also be recompiled.

F. Further Advantageous Embodiments of the Invention

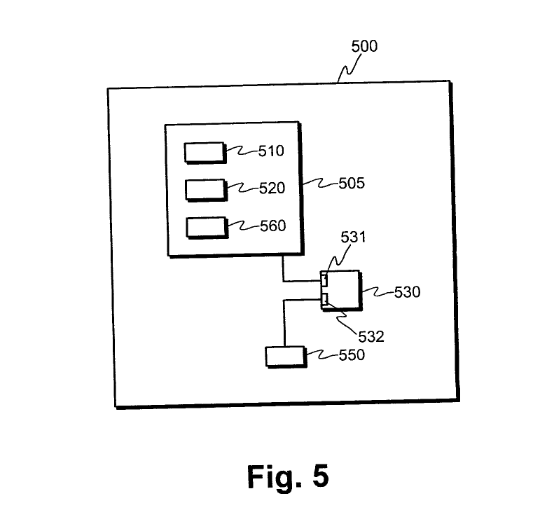

The invention can be implemented in many other forms as well than as a method. For example, the invention can be implemented as a system for processing of data packets according to compiled filter code. An example of such a system is illustrated in FIG. 5. According to this embodiment, the system comprises means 505 for managing the compiled filter code in a plurality of pieces.

According to a further advantageous embodiment of the invention, the system further comprises means 510 for incrementally compiling a set of rules and for producing at least one piece of code, and means 520 for updating a memory means 530 with said at least one piece of code.

According to a further advantageous embodiment of the invention, the system further comprises means 505, 550 for implementing shadow paging of pages of filter code.

According to a further advantageous embodiment of the invention, the system further comprises

means 550 for processing packets according to at least one first set of code pages,

means 560 for creating a second set of code pages to represent the set of code pages to be used after a certain point in time,

means 550 for processing packets received after said certain point in time according to said second set of code pages, and

means 550 for processing packets received before said certain point in time according to said at least one first set of code pages.

According to an advantageous embodiment of the invention, the means 550 for processing packets maintains information for each of packets being processed which specifies which set of code pages is to be used to process the packet. When a new packet is received and taken into processing, the packet processing means 550 starts processing a packet according to the code page set which is newest at that time, and processes the packet completely according to that code page set, even if new code page sets are created during the processing of that packet.

According to a still further advantageous embodiment of the invention, the system further comprises a memory component 530 having a first access port 531 and a second access port 532, and means 550 for processing data packets, said means for processing data packets 550 being arranged to access said memory component via said first access port, and said means 505 for managing the compiled filter code being arranged to access said memory component via said second access port.

The system 500 can be implemented in a computer network node 500, which can be for example a virtual private network (VPN) node, a router node, a firewall node, or for example a workstation of a user.

The invention can also be implemented as a computer software program product 500 by implementing said means using computer software program code. The program product can be for example a standalone application, such as an application for a personal VPN node for a user's workstation. The program product can also be implemented as a software routine library or module for inclusion into other sofware products.

G. Further Considerations

As previously described, the invention can very advantageously be used in processing according of data packets according to the IPSec protocol. However, the invention is not limited to control of packets according to the IPSec protocol, since the invention can be used in any application using compiled filter code for filtering of packets, or more generally, for classification of packets. Packet filtering can be used, among others, in the following applications:

routing of packets in general

control of multicast routing of packets

processing of packets in a firewall according to the firewall rules

processing of packets in VPN (virtual private network) applications

processing of packets according to quality of service parameters

adding differentiated services labels to data packets according to desired quality of service parameters

selection of packet processing in NAT (network address translation) nodes performing IPv4 and IPv6 processing

determination of content type in real time transmission protocol packets, such as in RTP (real-time protocol, described in RFC 1889) packets

billing and accounting functions, for example for directing packets to different processing nodes for debiting or crediting an account depending on the type of traffic, or for example for triggering a procedure for debiting or crediting an account,

packet header compression processing: filter code can be used to direct packets to different compression engines, i.e. for determining whether or not headers of a particular packet are to be compressed, and using which algorithm,

intrusion detection: many types of unusual behaviors can be expressed as a set of rules for application in filter code, which is very advantageus since intrusion detection needs considerable effort in fast networks.

It must be noted here that the previous list is not exhaustive by any means, and does not limit the invention in any way.

The invention can be used in many different types of environments, such as in a general purpose computer executing a general purpose operating system, or for example in dedicated routers or other dedicated packet processing systems. In addition to applications where the volume of packet traffic is high, the invention provides also considerable advantages in applications, where the available processing power is small compared to the volume of packet traffic, such as in low-power embedded applications, or in low-powered computing devices such as PDA's (personal digital assistans) or wireless terminals such as cellular phones capable of processing packet data.

The invention can also be realized in many different ways. For example, the invention can be realized in software in various ways: as standalone application programs, as routine libraries or modules for inclusion in other programs, in binary code or in source code stored in various kinds of media, such as fixed disks, CD-ROMs, electronic memory means such as RAM chips. The invention can also be realized as an integrated circuit such as a dedicated ASIC circuit (application specific integrated circuit) or as PGA circuit (programmable gate array), in which the previously described methods and means are implemented by electronic circuit means in the integrated circuits. Further, the invention can be realized as a part of a network node for performing various packet processing functions such as those described previously.

In this specification the term piece of code refers to a part of a larger body of code, such as a set of bytes to be inserted at a certain location of a larger body of code in a memory means. Specifically, the term piece of code is not intended to cover the totality of compiled filter code in a memory means representing the compiled version of a whole set of filter rules.

In view of the foregoing description it will be evident to a person skilled in the art that various modifications may be made within the scope of the invention. While a preferred embodiment of the invention has been described in detail, it should be apparent that many modifications and variations thereto are possible.

1. Method for managing compiled filter code for processing data packets wherein compiled filter code is managed in a plurality of pieces.

2. Method according to claim 1 comprising the steps of
incrementally compiling at least one rule for obtaining a piece of code by a rule compiling entity,
transmission of said piece of filter code from a rule compiling entity to a packet processing entity,
pausing of processing of packets by said packet processing entity,
writing of said piece of filter code to memory means, and
continuing of processing of packets by said packet processing entity.

3. Method according to claim 1 comprising the steps of
incrementally compiling at least one rule for obtaining a piece of code by a rule compiling entity,
signalling from said rule compiling entity to a packet processing entity that a new piece of code is compiled,
signalling from said packet processing entity to said rule compiling entity that said packet processing entity is ready for storage of said piece of code,
writing said piece of code to a memory means, and
signalling from said rule compiling entity to said packet processing entity that said piece of code is written to said memory means.

4. Method according to claim 1 wherein
said pieces are pages having a predetermined length.

5. Method according to claim 4 wherein
shadow paging is used.

6. Method according to claim 5 comprising the steps of
processing packets according to at least one first set of code pages,
creating a second set of code pages to represent the set of code pages to be used after a certain point in time,
processing packets received after said certain point in time according to said second set of code pages, and
processing packets received before said certain point in time according to said at least one first set of code pages.

7. Method according to claim 6 comprising within said step of creating a second set of code pages the steps of
assigning members of an existing code page set to be members of said second set of code pages, and
removing a code page from said second set of code pages.

8. Method according to claim 6 comprising within said step of creating a second set of code pages the steps of
creating a new code page, and
assigning said new code page to be a member of said second set of code pages.

9. Method according to claim 6 comprising the step of removing a code page from the memory element storing the code pages, when the code page is not any more a member of any set of code pages in use.

10. Method according to claim 4 wherein each page of code is associated with a reference number for observing the order of the code pages.

11. Method according to claim 10 wherein the order of any two code pages is determined by comparing values of v(x) calculated from the reference numbers associated with the code pages, v(x) being calculated substantially by the formula
v(x)=r(x)−r(b)modM
where r(x) is the reference number associated with a code page x being compared, r(b) the reference number of the base code page, and M the size of the set of allowed reference numbers {0, 1, 2, . . . , M−1}.

12. Computer software program product for processing data packets based on compiled filter code comprising computer program code means for managing the compiled filter code in a plurality of pieces.

13. Computer software program product according to claim 12 further comprising
computer program code means for incrementally compiling at least one rule and for producing at least one piece of code, and
computer program code means for updating a memory means with said at least one piece of code.

14. Computer software program product according to claim 12 further comprising
computer program code means for implementing shadow paging of pages of filter code.

15. Computer software program product according to claim 14 further comprising
computer program code means for processing packets according to at least one first set of code pages,
computer program code means for creating a second set of code pages to represent the set of code pages to be used after a certain point in time,
computer program code means for processing packets received after said certain point in time according to said second set of code pages, and
computer program code means for processing packets received before said certain point in time according to said at least one first set of code pages.

16. Computer software program product according to claim 12 wherein the computer software program product is a software routine library.

17. A computer program comprising instructions adapted for carrying out the steps of the method according to any one of claims 1 to 11.

18. Computer network node for processing of data packets according to compiled filter code comprising means for managing the compiled filter code in a plurality of pieces.

19. Computer network node according to claim 18 further comprising
means for incrementally compiling at least one rule and for producing at least one piece of code, and
means for updating a memory means with said at least one piece of code.

20. Computer network node according to claim 18 further comprising means for implementing shadow paging of pages of filter code.

21. Computer network node according to claim 18 further comprising
means for processing packets according to at least one first set of code pages,
means for creating a second set of code pages to represent the set of code pages to be used after a certain point in time,
means for processing packets received after said certain point in time according to said second set of code pages, and
means for processing packets received before said certain point in time according to said at least one first set of code pages.

22. Computer network node according to claim 18 wherein the node
is a virtual private network node.

23. Computer network node according to claim 18 wherein the node
is a router node.

24. Computer network node according to claim 18 wherein the node
is a firewall node.

25. Computer network node according to claim 18 wherein the node
is a workstation.

26. System for processing of data packets according to compiled filter code comprising
means for managing the compiled filter code in a plurality of pieces.

27. System according to claim 26 comprising
means for incrementally compiling a set of rules and for producing at least one piece of code, and
means for updating a memory means with said at least one piece of code.

28. System according to claim 26 comprising
means for implementing shadow paging of pages of filter code.

29. System according to claim 26 further comprising
means for processing packets according to at least one first set of code pages,
means for creating a second set of code pages to represent the set of code pages to be used after a certain point in time,
means for processing packets received after said certain point in time according to said second set of code pages, and
means for processing packets received before said certain point in time according to said at least one first set of code pages.

30. System according to claim 26 further comprising
a memory component having a first access port and a second access port, and means for processing data packets, said means for processing data packets being arranged to access said memory component via said first access port, and
said means for managing the compiled filter code being arranged to access said memory component via said second access port.
